(19) United States
(12) Patent Application Publication
(10) Pub. No.: US 2018/0066125 A1
(43) Pub. Date: Mar. 8, 2018

(54) PLASTICIZER COMPOSITION, RESIN COMPOSITION AND METHOD OF PREPARING THE SAME

(71) Applicant: LG CHEM, LTD., Seoul (KR)

(72) Inventors: Hyun Kyu KIM, Daejeon (KR); Mi Yeon LEE, Daejeon (KR); Jeong Ju MOON, Daejeon (KR); Joo Ho KIM, Daejeon (KR); Seok Ho JEONG, Daejeon (KR)

(21) Appl. No.: 15/558,757

(22) PCT Filed: Jul. 28, 2016
(86) PCT No.: PCT/KR2016/008322

§ 371 Date: Sep. 15, 2017

(30) Foreign Application Priority Data
Jul. 28, 2015 (KR) 10-2015-0106763

(51) Int. Cl. C08K 5/00; C08K 5/12; C08J 5/18

(52) U.S. Cl. CPC C08K 5/0016; C08L 57/00; C08J 5/18; C08K 5/12

(57) ABSTRACT

The present invention relates to a plasticizer composition, a resin composition and a method of preparing the same. A plasticizer capable of improving properties such as viscosity, migration, processability and plasticizing efficiency, which are required for sheet formulation when used as a plasticizer of a resin composition by improving poor properties caused by structural limitations, and a resin composition including the same may be provided.

### CROSS-REFERENCE TO RELATED APPLICATION

This application claims priority to and the benefit of Korean Patent Application No. 10-2015-0106763, filed on Jul. 28, 2015, the disclosure of which is incorporated herein by reference in its entirety.

### TECHNICAL FIELD

### Technical Field

The present invention relates to a plasticizer composition, a resin composition and a method of preparing the same.

### Background Art

Conventionally, a plasticizer forms an ester through a reaction between an alcohol and a polycarboxylic acid such as phthalic acid or adipic acid. In addition, in consideration of domestic and international regulations for phthalate-based plasticizers harmful to humans, there is ongoing research on plasticizer compositions that can replace phthalate-based plasticizers such as terephthalate-, adipate-, and other polymer-based plasticizers.

Meanwhile, to manufacture flooring materials, calendering sheets, films, and products produced in the extruding/injecting industry, a suitable plasticizer meeting required quality should be used. In the case of calendering sheets and PVC compounds for films, according to properties required for specifications, i.e., tensile strength, elongation, volatile loss, migration, processability and the like, a PVC resin is mixed with a supplementary raw material such as a filler, a stabilizer or the like.

As an example, among plasticizer compositions applicable to PVC, when diisononyl terephthalate is used, high viscosity, low processability, poor plasticizing efficiency and poor workability are exhibited.

Accordingly, there is a need to develop a product which has properties superior to those of the diisononyl terephthalate or a novel composition product including diisononyl terephthalate, and continuously conduct research on the most suitable technology for the use thereof as a plasticizer for vinyl chloride-based resins.

### DISCLOSURE

### Technical Problem

Therefore, during research on plasticizers, the present inventors verified a plasticizer composition capable of improving poor properties caused by structural limitations, and thus completed the present invention.

That is, an object of the present invention is to provide a plasticizer capable of improving properties such as volatile loss, migration, plasticizing efficiency, stress migration, absorption rate and the like, which are required for sheet formulation when used as a plasticizer of a resin composition, a method of preparing the same, and a resin composition including the same.

### Technical Solution

According to an embodiment of the present invention, there is provided a plasticizer composition which includes diisononyl terephthalate; and a butyl terephthalate-based compound represented by Chemical Formula 1 below.

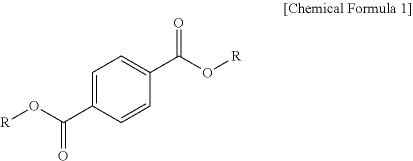

In Chemical Formula 1, R is a butyl group or an isobutyl group.

The weight ratio of the diisononyl terephthalate to the butyl terephthalate-based compound may be 70:30 to 30:70.

The butyl terephthalate-based compound may be any one selected from the group consisting of diisobutyl terephthalate, dibutyl terephthalate and a combination thereof.

According to another embodiment of the present invention, there is provided a resin composition which includes 100 parts by weight of a resin; and 5 to 150 parts by weight of the above-described plasticizer composition.

The resin may be one or more selected from the group consisting of ethylene vinyl acetate, polyethylene, polypropylene, polyvinyl chloride, polystyrene, polyurethane and thermoplastic elastomers.

The resin composition may be one or more materials selected from the group consisting of electric wires, flooring materials, interior materials for automobiles, films, sheets and tubes, which are prepared through calendering, extruding or injecting processes.

### Advantageous Effects

A plasticizer composition according to an embodiment of the present invention can exhibit excellent properties such as plasticizing efficiency, tensile strength and elongation rate as well as migration resistance and volatilization resistance when used in a resin composition.

### MODES OF THE INVENTION

### EXAMPLE

Hereinafter, the present invention will be described in detail with reference to the following examples. However, the examples according to the present invention may be changed in many different forms and should not be construed as being limited to the embodiments set forth herein. Rather, these examples are provided so that this disclosure will be thorough and complete, and will fully convey the scope of the present invention to those of ordinary skill in the art.

### Preparation Example 1

### Preparation of diisononyl terephthalate

498.0 g of purified terephthalic acid (TPA), 1,296 g of isononyl alcohol (INA) (a molar ratio of TPA: INA=1.0: 3.0), and 1.54 g (0.31 parts by weight with respect to 100 parts by weight of TPA) of a titanium-based catalyst (tetraisopropyl titanate (TIPT)) were added to a 3 L four-neck reactor equipped with a cooler, a condenser, a decanter, a reflux pump, a temperature controller, a stirrer and the like, and the temperature of the reactor was slowly raised up to about 170° C. The generation of produced water started at about 170° C., esterification was performed at a reaction temperature of about 220° C. under an atmospheric pressure condition for about 4.5 hours while continuously introducing nitrogen gas, and was terminated when an acid value reached 0.01.

After the reaction was completed, distillation extraction was performed under reduced pressure for 0.5 to 4 hours to remove unreacted raw materials. To remove the unreacted raw materials at a predetermined amount level or less, steam extraction was performed for 0.5 to 3 hours under reduced pressure using steam. A temperature of a reaction solution was cooled to about 90° C. to perform neutralization treatment using an alkaline solution. In addition, washing could be performed, and thereafter, the reaction solution was dehydrated to remove water. A filtering material was introduced into the dehydrated reaction solution, stirred for a predetermined period of time, and then filtered, thereby finally obtaining 1,241 g of diisononyl terephthalate (yield: 99.0%).

### Preparation Example 2

### Preparation of diisobutyl terephthalate

Diisobutyl terephthalate was obtained by using isobutanol instead of isononyl alcohol, performing a reaction for 6 to 24 hours, using methanesulfonic acid as a catalyst in the same amount as in Preparation Example 1, and performing the same purification method as in Preparation Example 1.

### Preparation Example 3

### Preparation of dibutyl terephthalate

Dibutyl terephthalate was obtained in the same manner as in Preparation Example 2 except that butanol was used instead of isononyl alcohol.

The materials according to Preparation Examples 1 to 3 were used to prepare examples and comparative examples as follows.

TABLE 1

| | | | Mixing weight |
|---|---|---|---|
| No. | First composition | Second composition | ratio |
| Example 1 | DINTP | DBTP | 7:3 |
| Example 2 | DINTP | DBTP | 5:5 |
| Example 3 | DINTP | DiBTP | 6:4 |
| Example 4 | DINTP | DBTP + DiBTP | 1:1:1 |
| Comparative | DINTP | — | — |
| Example 1 | | | |
| Comparative | DBTP | — | — |
| Example 2 | | | |
| Comparative | DiBTP | — | — |
| Example 3 | | | |
| Comparative | DINTP | DBTP | 95:5 |
| Example 4 | | | |
| Comparative | DINTP | DBTP | 8:2 |
| Example 5 | | | |
| Comparative | DINTP | DBTP | 2:8 |
| Example 6 | | | |
| Comparative | DEHTP | DBTP | 6:4 |
| Example 7 | | | |
| Comparative | DEHTP | DiBTP | 6:4 |
| Example 8 | | | |

### Experimental Example 1

### Sheet Formulation

Specimens were prepared with reference to ASTM D638 using the plasticizer compositions according to Examples 1 to 4 and Comparative Examples 1 to 8. 30 parts by weight of each plasticizer composition, 3 parts by weight of a barium-zinc stabilizer (BZ153T) and 0.5 parts by weight of TiO₂ (KA-100) were mixed with 100 parts by weight of PVC in a 3 L super mixer at 98° C. and 700 rpm for 2 minutes, and then the resulting mixture was subjected to roll-milling at 170° C. for 4 minutes, thereby manufacturing sheets having a thickness of 5 mm.

The sheets were pressed for 2.5 minutes (low pressure) and 3 minutes (high pressure) at 180° C., and cooled for 3 minutes to manufacture sheets having a thickness of 1 to 3 mm The sheets were manufactured into several type ‘C’ dumbbell-shaped specimens.

Each specimen was subjected to a test for properties as described below, result of which are shown in Table 2 below.

<Test Items>

Measurement of Hardness

According to ASTM D2240, Shore hardness was measured at 25° C. under 3 T and 10 s conditions.

Measurement of Tensile Strength

According to ASTM D638, each specimen was pulled at a cross head speed of 200 mm/min (1 T) using a tester, U.T.M, (Manufacturer; Instron, Model No.; 4466), and a position at which the specimen was broken was detected. A tensile strength was calculated as follows:

Tensile strength (kgf/cm²)=Load value (kgf)/Thickness (cm)×Width (cm)

Measurement of Elongation Rate

According to ASTM D638, each specimen was pulled at a cross head speed of 200 mm/min (1 T) using the U.T.M, and a position at which the specimen was broken was detected. An elongation rate was calculated as follows:

Elongation rate (%)=Length after elongation/Initial length×100

Measurement of Migration Loss

An experimental specimen having a thickness of 2 mm or more was obtained according to KSM-3156, PS plates were attached to both sides of the specimen, and then a load of 1 kgf/cm² was applied thereto. The specimen was kept in a forced convection oven (80° C.) for 72 hours, then taken out of the oven, and cooled at room temperature for 4 hours. Then, after the PS plates attached to both sides of the specimen were removed, weights before and after being kept in the oven were measured and thus a migration loss was calculated by the equation as follows.

Migration loss (%)={(Initial weight of specimen at room temperature−Weight of specimen after being kept in oven)/Initial weight of specimen at room temperature}×100

Measurement of Volatile Loss

The prepared specimen was processed at 100° C. for 72 hours, and a weight of the specimen was measured as follows.

Volatile loss (wt %)=Initial weight of specimen−(Weight of specimen after being processed at 100° C. for 72 hours)/Initial weight of specimen×100

Stress Test

A stress test was performed by leaving the specimen in a bent state at room temperature for a predetermined period of time, and then a degree of migration (leaking degree) was observed and expressed as a numerical value. In the test, values closer to 0 indicate excellent characteristics.

Measurement of Absorption Rate

An absorption rate was evaluated by measuring the time taken to reach a state in which after resin and ester compounds were mixed together using a planetary mixer (Brabender, P600) at 80° C. and 60 rpm, a torque of the mixer was stabilized.

TABLE 2

| | Hardness | Tensile | Elongation | Migration | Volatile | | Absorption |
|---|---|---|---|---|---|---|---|
| | (Shore | strength | rate | loss | loss | Stress | rate |
| | “A”) | (kg/cm²) | (%) | (%) | (%) | test | (sec) |
| Example 1 | 93.2 | 265.68 | 332.13 | 0.92 | 2.95 | 0.5 | 5:28 |
| Example 2 | 93.0 | 264.52 | 331.32 | 0.95 | 3.40 | 0.5 | 4:12 |
| Example 3 | 93.0 | 265.83 | 331.16 | 0.89 | 3.01 | 0 | 4:24 |
| Example 4 | 92.2 | 260.53 | 334.96 | 1.02 | 3.24 | 0 | 4:01 |
| Comparative | 95.0 | 248.90 | 325.20 | 0.95 | 0.97 | 3.0 | 7:45 |
| Example 1 | | | | | | | |
| Comparative | 91.3 | 209.92 | 259.23 | 1.72 | 7.84 | 0.5 | 3:02 |
| Example 2 | | | | | | | |
| Comparative | 91.5 | 211.62 | 248.63 | 2.08 | 8.56 | 0.5 | 3:34 |
| Example 3 | | | | | | | |
| Comparative | 94.0 | 257.93 | 328.83 | 0.82 | 1.69 | 2.0 | 7:08 |
| Example 4 | | | | | | | |
| Comparative | 93.6 | 259.11 | 329.23 | 0.90 | 2.83 | 1.5 | 5:56 |
| Example 5 | | | | | | | |
| Comparative | 92.4 | 220.13 | 274.63 | 1.56 | 7.02 | 1.0 | 3:37 |
| Example 6 | | | | | | | |
| Comparative | 92.3 | 248.67 | 328.01 | 1.05 | 4.42 | 0.5 | 3:52 |
| Example 7 | | | | | | | |
| Comparative | 92.5 | 250.31 | 324.23 | 1.11 | 4.89 | 0.5 | 4:11 |
| Example 8 | | | | | | | |

Referring to Table 2, it can be confirmed that Examples 1 to 4 exhibited an improvement in plasticizing efficiency, elongation rate and tensile strength compared to Comparative Example 1 in which DINTP was used alone, and, in particular, Examples 1 to 4 in which 30 wt % or more of a butyl terephthalate-based compound was added exhibited a significant improvement in a stress test and absorption rate. Also, it can be confirmed that Comparative Examples 2 and 3 in which a butyl terephthalate-based compound was used alone exhibited significantly poor mechanical properties such as tensile strength or elongation rate, and when a butyl terephthalate-based compound was used in combination with DINTP, excellent tensile strength or an excellent elongation rate was exhibited compared to that of each material.

In addition, it can be confirmed that Examples 1 to 4 exhibited a stress test and absorption rate or hardness at similar levels compared to Comparative Examples 7 and 8 in which DEHTP was used as a first plasticizer instead of DINTP, but an obvious improvement in tensile strength, elongation rate and migration loss was also exhibited, and, in particular, volatile loss was significantly excellent.

Additionally, it can be confirmed that, in the case of Comparative Examples 4 to 6 in which a ratio of diisononyl terephthalate and dibutyl terephthalate was not adjusted to 7:3 to 3:7, tensile strength and elongation rate were significantly deteriorated, and resistance to stress and absorption rate were poor to a level at which it is difficult to be applied to the product, or the amount of loss was too large due to excessive migration loss and volatile loss to be applied to the product.

Therefore, it can be confirmed that, according to obvious properties of DINTP and DBTP when DINTP and DBTP were used in combination as in the present invention, when a large amount of any one composition was used, inferior quality was exhibited, but when an optimal combination for use was set within a range of a predetermined ratio, a dramatic effect on properties was exhibited. In other words, when two materials having extreme properties are mixed in an optimal ratio, a plasticizer composition may have marketability and competitiveness in the use of a plasticizer, which is meaningful to find quality synergy between two materials, which allows the use of a plasticizer.

Hereinafter, the present invention will be described in detail.

First, the present invention has a technical feature in providing a plasticizer composition capable of improving poor properties caused by structural limitations.

According to an embodiment of the present invention, there is provided a plasticizer composition which includes diisononyl terephthalate and a butyl terephthalate-based compound. As such, a resin prepared using a plasticizer composition in which diisononyl terephthalate and a butyl terephthalate-based compound are mixed together may exhibit more excellent properties such as plasticizing efficiency, tensile strength, elongation rate, migration, volatile loss and the like compared to a resin prepared with a plasticizer composition including the diisononyl terephthalate alone.

The butyl terephthalate-based compound may be represented by Chemical Formula 1 below.

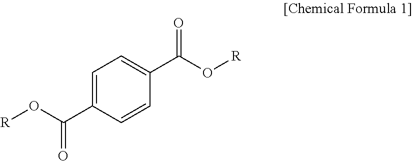

In Chemical Formula 1, R is a butyl group or an isobutyl group.

That is, the butyl terephthalate-based compound may be dibutyl terephthalate and/or diisobutyl terephthalate. As such, when diisononyl terephthalate is used together with a butyl terephthalate-based compound, it is possible to solve problems such as a gelling phenomenon caused by a high absorption rate when a butyl terephthalate-based compound is used alone and a phenomenon in which processing is not possible due to an increase in viscosity.

In this case, the diisononyl terephthalate and butyl terephthalate-based compound may be included in the plasticizer composition in a weight ratio of 99:1 to 1:99, preferably, 70:30 to 30:70.

When the two materials are outside the above ratio, that is, when an excessive amount of diisononyl terephthalate and a small amount of a butyl terephthalate-based compound are included, an absorption rate or resistance to stress may be poor. On the other hand, when an excessive amount of butyl terephthalate is included, properties such as volatile loss and migration loss may be deteriorated. Also, when basic properties such as tensile strength and elongation rate are outside the above ranges, properties may be deteriorated regardless of which is excessive.

Therefore, to control suitable migration and volatile loss for applications such as calendering sheets, films, extrusion and injection products while maintaining tensile strength and an elongation rate at an excellent level, a mixing ratio of the diisononyl terephthalate and butyl terephthalate-based compound should be adjusted to the above range.

In the present invention, a method of preparing the plasticizer composition may be performed by a blending method, and the blending method is, for example, as follows.

Diisononyl terephthalate and a butyl terephthalate-based compound are prepared.

The diisononyl terephthalate and butyl terephthalate-based compound may be blended to prepare the plasticizer composition.

In the blending method, the terephthalate-based compound may be prepared by introducing terephthalic acid to an alcohol and adding a catalyst to induce a reaction under a nitrogen atmosphere; removing an unreacted alcohol and neutralizing an unreacted acid; and performing dehydration and filtration through distillation under reduced pressure.

In addition, the alcohol used in the blending method may be included at 150 to 500 mol %, 200 to 400 mol %, 200 to 350 mol %, 250 to 400 mol %, or 270 to 330 mol % based on 100 mol % terephthalic acid.

Meanwhile, the catalyst used in the blending method may be any catalyst that can be used in esterification without particular limitation. For example, the catalyst may be one or more selected from an acid catalyst such as sulfuric acid, hydrochloric acid, phosphoric acid, nitric acid, p-toluenesulfonic acid, methanesulfonic acid, ethanesulfonic acid, propanesulfonic acid, butanesulfonic acid, alkyl sulfuric acid and the like, a metal salt such as lactic acid aluminum, lithium fluoride, potassium chloride, cesium chloride, calcium chloride, iron chloride, aluminum phosphate and the like, a metal oxide such as a heteropoly acid and the like, and an organic metal such as a natural/synthetic zeolite, cation and anion-exchange resins, tetraalkyl titanate, a polymer thereof and the like. As a specific example, the catalyst may be tetraalkyl titanate.

The amount of a catalyst to be used may vary according to the type thereof. For example, a homogeneous catalyst may be used in an amount of 0.01 to 5 wt %, 0.01 to 3 wt %, 1 to 5 wt %, or 2 to 4 wt % with respect to 100 wt % of a total weight of the reactants, and a heterogeneous catalyst may be used in an amount of 5 to 200 wt %, 5 to 100 wt %, 20 to 200 wt %, or 20 to 150 wt % with respect to a total weight of the reactants.

In this case, the reaction temperature may be in a range of 180 to 280° C., 200 to 250° C., or 210 to 230° C.

According to another embodiment of the present invention, there is provided a resin composition, which includes the plasticizer composition thus prepared at 5 to 150 parts by weight, 40 to 100 parts by weight, or 40 to 50 parts by weight with respect to 100 parts by weight of a resin such as ethylene vinyl acetate, polyethylene, polypropylene, polyvinyl chloride, polystyrene, polyurethane, thermoplastic elastomers or a mixture thereof, and is effective in compound formulation and/or sheet formulation.

According to an embodiment of the present invention, the resin composition may further include a filler.

The filler may be included at 0 to 300 parts by weight, preferably, 30 to 200 parts by weight, and more preferably, 30 to 150 parts by weight based on 100 parts by weight of the resin.

According to an embodiment of the present invention, the filler may be any filler known in the art and is not particularly limited. For example, the filler may be a mixture of one or more selected from silica, magnesium carbonate, calcium carbonate, hard charcoal, talc, magnesium hydroxide, titanium dioxide, magnesium oxide, calcium hydroxide, aluminum hydroxide, aluminum silicate, magnesium silicate and barium sulfate.

In addition, according to an embodiment of the present invention, the resin composition may further include other additives such as a stabilizer and the like if necessary.

The other additives such as a stabilizer and the like may be included, for example, at 0 to 20 parts by weight, preferably, 1 to 15 parts by weight based on 100 parts by weight of the resin.

According to an embodiment of the present invention, the stabilizer that can be used may be, for example, a calcium-zinc-based (Ca—Zn-based) stabilizer such as a Ca—Zn composite stearate or the like, but the present invention is not particularly limited thereto.

The resin composition may be applied to various fields. As a non-limiting example, the resin composition may be applied to manufacture calendered, extrusion and injection products such as electric wires, flooring materials, interior materials for automobiles, films, sheets, tubes and the like.

1. A plasticizer composition comprising diisononyl terephthalate; and a butyl terephthalate-based compound represented by Chemical Formula 1 below. 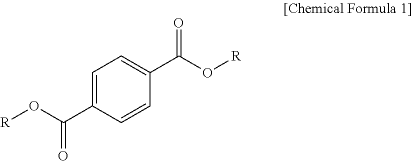
wherein R is a butyl group or an isobutyl group.

2. The plasticizer composition of claim 1, wherein the weight ratio of the diisononyl terephthalate to the butyl terephthalate-based compound is 70:30 to 30:70.

3. The plasticizer composition of claim 1, wherein the butyl terephthalate-based compound is any one selected from the group consisting of diisobutyl terephthalate, dibutyl terephthalate and a combination thereof.

4. A resin composition comprising 100 parts by weight of a resin; and 5 to 150 parts by weight of the plasticizer composition of claim 1.

5. The resin composition of claim 4, wherein the resin is one or more selected from the group consisting of ethylene vinyl acetate, polyethylene, polypropylene, polyketone, polyvinyl chloride, polystyrene, polyurethane and thermoplastic elastomers.

6. The resin composition of claim 4, wherein the resin composition is one or more materials selected from the group consisting of electric wires, flooring materials, interior materials for automobiles, films, sheets and tubes, which are prepared by one or more processing methods selected from the group consisting of calendering, extruding and injecting processes.
